(19) United States
(12) Patent Application Publication
(10) Pub. No.: US 2015/0311773 A1
(43) Pub. Date: Oct. 29, 2015

(54) METHOD OF USING A FILLER SHEET HAVING A FLAT SURFACE TO REDUCE CORE LOSS AND WELD FAILURE IN LAMINATED STACKED STATORS

(71) Applicant: GM Global Technology Operations LLC, Detroit, MI (US)

(72) Inventor: Huaxin Li, Rochester Hills, MI (US)

(73) Assignee: GM Global Technology Operations LLC, Detroit, MI (US)

(21) Appl. No.: 14/271,072

(22) Filed: May 6, 2014

Related U.S. Application Data
(63) Continuation-in-part of application No. 14/263,054, filed on Apr. 28, 2014, now abandoned.

(51) Int. Cl. H02K 15/03; B23K 31/02; B23K 20/00

(52) U.S. Cl. CPC H02K 15/03; B23K 20/002; B23K 31/02

(57) ABSTRACT

A number of variations may include a method including welding a filler sheet having a flat surface to a plurality of stacked magnetic segments to form a stator core.

### CROSS-REFERENCE TO RELATED APPLICATIONS

This is a continuation-in-part of U.S. application Ser. No. 14/263,054, filed Apr. 28, 2014.

### TECHNICAL FIELD

The field to which the disclosure generally relates to includes methods of making stacked stators.

### BACKGROUND

Stator cores may include a plurality of stacked magnetic segments punched or stamped out of an electromagnetic sheet.

### SUMMARY OF SELECT ILLUSTRATIVE VARIATIONS

A number of variations may include a method including welding a filler sheet having a flat surface to a plurality of stacked magnetic segments to form a stator core.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a perspective view showing a plurality of stacked magnetic segments constructed and arranged to form a stator core according to a number of variations.

FIG. 2 is a side view of the product shown in FIG. 1.

FIG. 3 is a top view of the ship product shown in FIG. 1.

FIG. 4 is a sectional view with portions removed showing a filler sheet having a flat surface placed in a channel formed in the outer periphery of a stack of stator segments according to a number of variations.

FIG. 5 illustrates a product shown in FIG. 4 after the filler sheet has been welded to the plurality of stacked stator segments according to a number of variations.

FIG. 6 illustrates a method which may include spot welding a filler sheet having a flat surface in a channel formed in the outer periphery of a plurality of stacked stator segments prior to welding the flat filler sheet to the plurality of stacked stator segments according to number of variations.

### DETAILED DESCRIPTION OF ILLUSTRATIVE VARIATIONS

The following description of the variations is merely illustrative in nature and is in no way intended to limit the scope of the invention, its application, or uses.

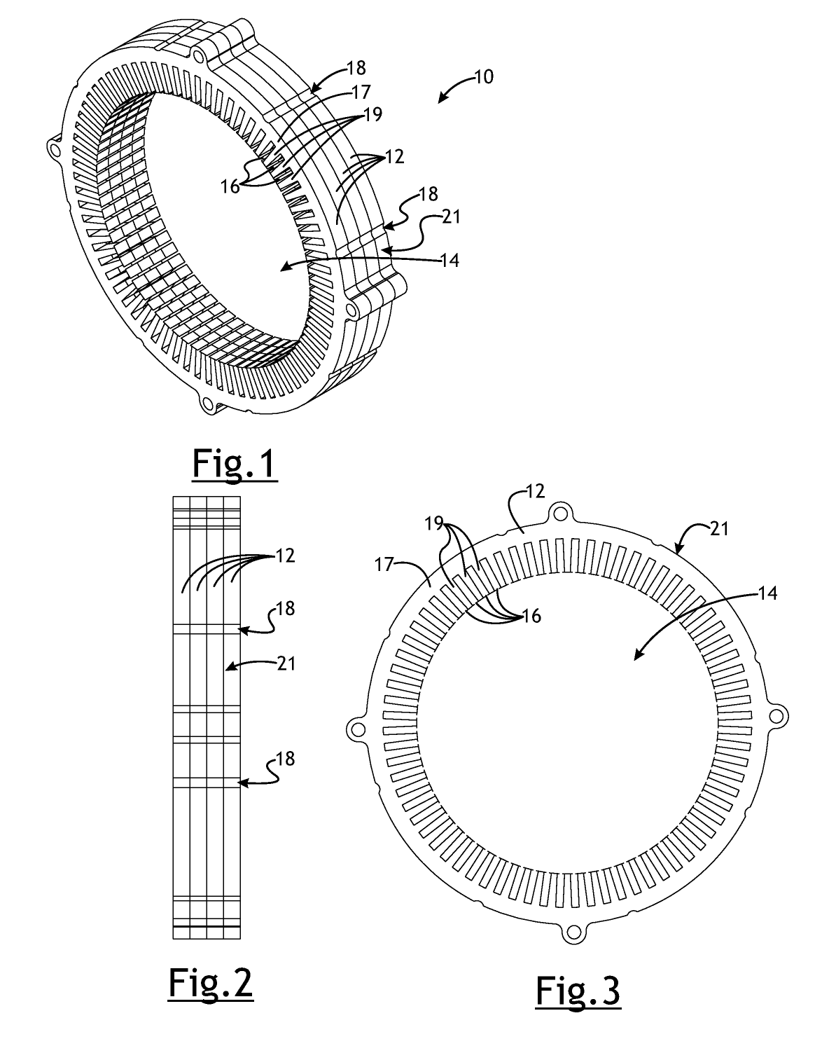

FIG. 1 illustrates a product 10 which may include a plurality of stacked electromagnetic stator segments 12. Each stator segment 12 be include a core back 17 which may have a generally annular configuration and a plurality of spaced apart teeth 19 extending radially inward from an inner circumferential portion of the core back 17. The teeth 19 may be arranged in a uniform annular pitch circumferentially and slots 16 may be define between adjacent teeth 17. Each core segment 12 may have a through hole 14 formed in the center thereof. Each core segment 12 may have an outer generally circumferential surface 21 in which a plurality of channels 18 may be formed therein and may extend generally in an axial direction with respect to the through hole 14. The stator segments 12 may be made for any material that may be magnetized including, for example but not limited to, at least one of rare-earth alloys or alloys including iron. In a number of variations the stator segments 12 may include stainless steel.

FIG. 2 is a side view of the product shown in FIG. 1 and FIG. 3 is a plan view of the product shown in FIG. 1.

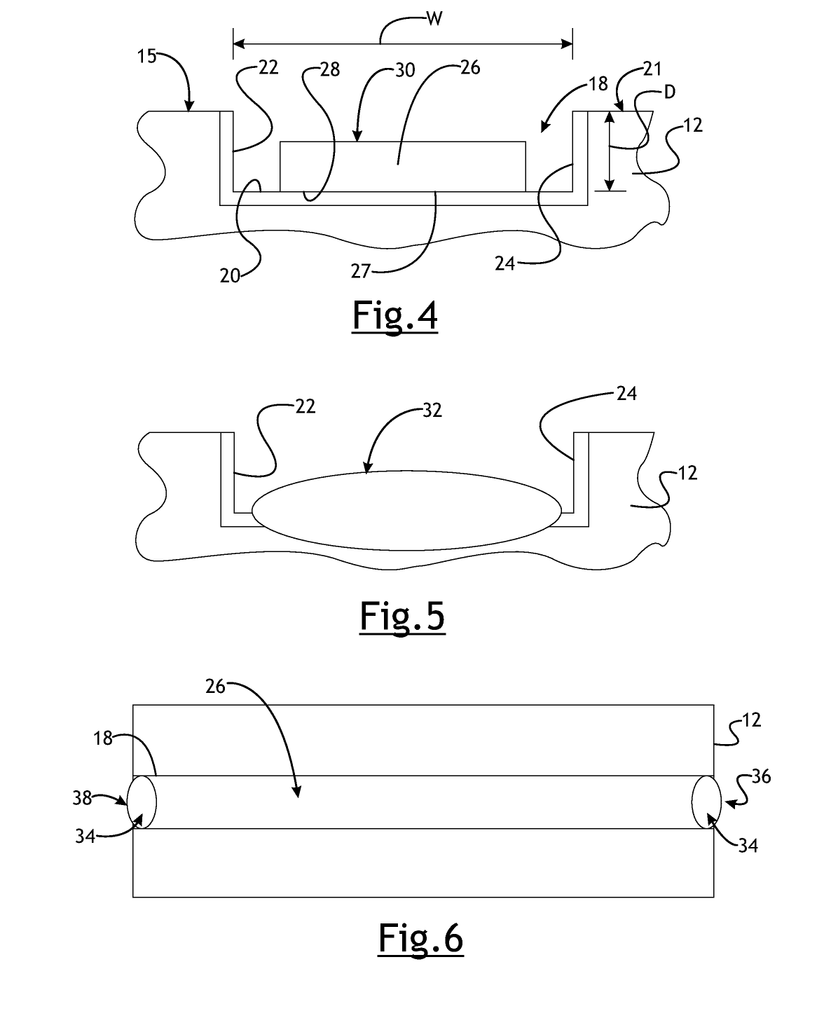

A number of variations are illustrated in FIG. 4 which may include a method including providing a channel 18 in an outer generally circumferential surface 21 of each of the stacked core segments 12. The channel 18 may be defined by a generally flat bottom wall 20 formed in each core segment 12 and a first side wall 22 and a spaced apart second sidewall 24 each extending from the bottom wall 20. In a number variations, each of the first sidewall 22 and the second sidewall 24 extend from the bottom wall 20 at a right angle (90 degrees). The number of other variations, each of the first sidewall 22 and second sidewall 24 extend from the bottom wall 20 at an angle ranging from 45-135°. The channel 18 may have a width W measured from the portions of the first side wall 22 and a second sidewall 24 which are furthest from each other. The width W in a number of variations may range from less than 2-10 mm, 2-8 mm, 4-6 mm, 3-5 mm or approximately 4 mm. In a number of variations the depth D of the channel measured from the outer circumferential surface 21 to the bottom wall 14 a range from 0-3 mm, 0.5-3 mm, 0-2 mm, 0.5-2 mm, 0-1.5 mm, 0-1.5 mm or approximately 1.5 mm. A filler sheet 26 may be placed in the channel 18. In a number of variations the filler sheet have a flat bottom surface 27 that may be place against the flat bottom wall 20 defining the channel 18. In a number of variations the filler sheet 26 may have a thickness of approximately 0.5-2 mm, 0.5-1.5 mm or 1 mm. The filler sheet 26 may be welded to the stack of stator cores 12 to secure the stack of stator cores together as shown in FIG. 5 thereby producing a weld bead 32.

Referring now to FIG. 6, in a number of variations, prior to welding the filler sheet 26, one or more spot welds 34 may be used to attach the filler sheet 26 to the stack of stator cores 12. In one variation, a first spot weld 36 may be formed at a first end of the elongated filler sheet 26 and a second spot weld 38 may be formed at a second end of the elongated filler sheet 26. Laser or TIG welding may be utilized to weld the filler sheet 26 to the stack of stator cores 12. A number of materials that may be utilized for these filler sheet 26 include nickel, nickel base alloys, manganese base alloys or austenite stainless steels. In a number of variations, the filler sheet 26 may include about 20-100% of nickel. High manganese austenite steel sheets may be utilized. In a number of variations manganese steel filler sheets may include 10-50% of manganese. In a number of variations, the filler sheet 26 may include a material that produces face centered cubic crystal metal in the weld. In a number of variations the size and configuration of the channel 18 may minimize core loss due to welding, may eliminate weld brittleness, and may minimize weld porosity.

The above description of select variations within the scope of the invention is merely illustrative in nature and, thus, variations or variants thereof are not to be regarded as a departure from the spirit and scope of the invention.

What is claimed is:

1. A method comprising providing a plurality of stacked stator segments, wherein the stacked stator segments include a generally circumferential outer surface having a channel defined therein, the channel being partially defined by a relatively flat bottom surface, placing a filler sheet in the channel with a flat surface of the filler sheet against the flat bottom surface, and welding the filler sheet to the stack of stator segments to hold the stack of stator segments together.

2. A method as set forth in claim 1 wherein the channel is partially defined by a first sidewall and a second sidewall extending upward from the flat bottom wall at an angle ranging from 45-135°.

3. A method as set forth in claim 1 wherein the channel is partially defined by a first sidewall and a spaced apart second sidewall each extending upward from the flat bottom wall at generally a 90° angle.

4. A method as set forth in claim 1 wherein the channel has a width ranging from about 2-8 mm.

5. A method as set forth in claim 1 wherein the channel has a height ranging from 0.5-3 mm.

6. A method as set forth in claim 1 wherein the filler sheet comprises nickel present in an amount ranging from 20-100%.

7. A method as set forth in claim 1 wherein the filler material comprises manganese present in the amount ranging from 20-100%.
